(19) United States
(12) Patent Application Publication
(10) Pub. No.: US 2024/0428127 A1
(43) Pub. Date: Dec. 26, 2024

(54) CONVERGENCE ASSESSMENT IN SUBPOPULATION-BASED FEATURE SELECTION

(71) Applicant: International Business Machines Corporation, Armonk, NY (US)

(72) Inventors: Uri Kartoun, Cambridge, MA (US); William Ogallo, Nairobi (KE); Girmaw Abebe Tadesse, Nairobi (KE); Catherine Wanjiru, Ongata Rongai (KE); Kenney Ng, Arlington, MA (US); VIBHA Anand, Cambridge, MA (US)

(21) Appl. No.: 18/339,536

(22) Filed: Jun. 22, 2023

(51) Int. Cl. G06N 20/00

(52) U.S. Cl. CPC G06N 20/00

(57) ABSTRACT

A training process a predictive model uses a dataset of features and an outcome. The method generates a table for a dataset comprising multiple features, the table contains values for each pair of features in the dataset, randomly selects features from the dataset, thereby creating a first subset of features, operates a propensity score matching using the randomly selected features to identify cases and controls using the outcome variable, rewards one or more features of a second subset of features in the multiple features that were not selected randomly, each feature of the second subset addresses a statistical significance criteria, updating each entry in the table with a reward distance between each pair of features, calculates a cumulative reward measure, iterating the steps until convergence, selects a final subset of features when a variability criteria of the cumulative reward measure addresses convergence criteria, and trains the predictive model.

### BACKGROUND

The present disclosure relates to machine learning, and more specifically, to improving the computerized performance of subpopulation-based feature selection by iteratively assessing convergence level.

In the field of machine learning, feature selection, also known as variable selection or attribute selection or covariate selection, refers to the process of selecting relevant data features for use in model construction. While a dataset can contain any number of features, feature selection techniques identify a subset of features that are the most useful for a data model. In particular, features that are irrelevant or redundant can typically be omitted from consideration without negatively impacting the performance of a corresponding data model. In fact, models with fewer features are typically preferable since such models are more computationally efficient and more interpretable.

Feature selection methods are useful for identifying the most informative features in a dataset. Under current methodologies, two problems may arise associated with the pre-defined arbitrary number of iterations. First, the method may stop iterating before identifying all the informative features, resulting in under-selection. Second, the method may continue to run unnecessarily, even after all informative features have been identified, leading to unnecessary computational processing. To avoid these problems, it is important to incorporate convergence assessment methodologies and criteria into feature selection methods.

### SUMMARY

According to one embodiment of the present invention, a feature selection method ranks features according to level of importance. A subset of these features could be used for a variety of purposes, including to train a predictive model. A plurality of subsets of features are randomly selected from a dataset comprising a plurality of cases and controls and a plurality of features. Cases and controls are matched to select a plurality of case-control subsets for each subset of features, each case-control subset having similar values for the corresponding subset of features. For each case-control subset, a statistical significance of each feature of the plurality of features absent from the subset of features used to match the case-control subset is identified and rewarded numerically. Subsets are continuously generated randomly and the cases and controls are matched in each iteration. The computer system includes a convergence function configured to determine when to cease the iterative process once a convergence criteria has been determined. If the method runs iterations that are found to result only a minor or no change in determining a final list of selected informative features then it reaches convergence and stops. The most important features are then used for a variety of computational purposes, such as to train a predictive model, for clustering, and to serve as an input for a foundation model.

Another disclosed embodiment includes a computer system for training a predictive model, the computer system includes one or more computer processors, one or more computer readable storage media, program instructions stored on the one or more computer readable storage media for execution by at least one of the one or more computer processors, the program instructions comprising instructions using a dataset of features and an outcome to (A) initiating a table for a dataset comprising a plurality of numerical values for each pair of features, (B) randomly selecting a plurality of features from the dataset, thereby creating a first subset of features, (C) operating a propensity score matching on the dataset using the randomly selected plurality of features, to identify a subset of cases and controls using the outcome variable, (D) rewarding one or more features of a second subset of features consisting of features in the plurality of features that were not selected randomly when each addresses a statistical significance criteria, (E) updating each entry in the table with a reward distance between each pair of features, (F) calculating a cumulative reward measure, (G) iterating steps (B)-(F) until a convergence criteria is met, (H) selecting a final subset of features when a variability criteria of the cumulative reward measure addresses a convergence criteria, and (I) training the predictive model using the final subset of selected features.

In another disclosed embodiment, a computer program product for training a predictive model, the computer program product comprising one or more computer readable storage media collectively having program instructions embodied therewith, the program instructions executable by a computer to cause the computer to rank features using a dataset, features, and an outcome: (A) initiating a table for a dataset comprising a plurality of numerical values for each pair of features, (B) randomly selecting a plurality of features from the dataset, thereby creating a first subset of features, (C) operating a propensity score matching on the dataset to identify a subset of cases and controls using the outcome variable, (D) rewarding one or more features of a second subset of features consisting of features in the plurality of features that were not selected randomly when each addresses a statistical significance criteria, (E) updating each entry in the table with a reward distance between each pair of features, (F) calculating a cumulative reward measure, (G) iterating steps (B)-(F) until a convergence criteria is met, (H) selecting a final subset of features when a variability criteria of the cumulative reward measures addresses a convergence criteria, and (I) training the predictive model using the final subset of selected features.

In at least one of the embodiments disclosed herein, the process further includes evaluating the predictive model against a reference model to validate accuracy of the predictive model using the final subset of selected features, wherein the predictive model and the reference models are trained using the dataset.

### BRIEF DESCRIPTION OF THE DRAWINGS

Generally, like reference numerals in the various figures are utilized to designate like components.

FIG. 1 is a block diagram depicting a computing environment for model development in accordance with an embodiment of the present invention;

FIG. 2 is a flow chart depicting a method of matching cases and controls in accordance with an embodiment of the present invention;

FIG. 3 is a flow chart depicting a method of selecting features in accordance with an embodiment of the present invention;

FIG. 4 is a flow chart depicting a method of evaluating model performance in accordance with an embodiment of the present invention; and

FIG. 5 is a block diagram depicting a computing device in accordance with an embodiment of the present invention.

FIG. 6 is a block diagram of an iterative feature selection process that iterates until a convergence point has been achieved.

FIG. 7A is a N×N table of feature distances in a feature set prior to any iterations according to one example.

FIG. 7B is a N×N table of feature distances in a feature set after a first iteration according to one example.

FIG. 7C is a N×N table of feature distances in a feature set after a second iteration according to one example.

FIG. 7D is a N×N table of feature distances in a feature set after a third iteration according to one example.

FIG. 7E is a N×N table of feature distances in a feature set after a fourth iteration according to one example.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The embodiments of the system disclosed herein relate to machine learning, and more specifically, to improving a computerized processing of data models used in machine learning by using a reduced quantity of features while maintaining accuracy. A predictive model refers to a data model that processes input data to forecast a selected outcome. For example, a predictive model may process clinical data of a patient to determine the most likely outcome of the patient (e.g., recovery from a disease, 30-day re-admission, 90-day mortality, 10-year incident cardiovascular disease, 6-month controlled blood pressure). In order to develop such a model, machine learning techniques are applied to train the model using a training sample of example clinical data that includes both types of outcome (e.g., recovered vs. not recovered from a disease). For the purposes of the predictive modeling, the types of outcome are classified in a binary fashion of either “a” or “not a”. In another embodiment it is possible for the method to handle continuous outcomes, which requires a processing step of binarizing the outcome values (e.g., based on mean, median, or alike).

A feature selection technique identifies certain data features in particular that are most useful as indicators of, or proxies for, the outcome of interest; the selected features are then used to develop a predictive model. The feature selection technique applies an iterative process to a large number of features with the goal of reducing the number of features to a smaller subset of particularly relevant features to be used for training the model. The iterative process identifies a relevance of each feature analyzed in each iteration, and is iterated until a convergence criteria is met. In a typical example, the convergence criteria represents a variability threshold. Application of the convergence criteria can reduce or eliminate under-selection problems where an insufficient number of iterations is used due to the arbitrarily selected number of iterations in previous systems being too small, and can reduce processing power and time waste when the arbitrary number of iterations in previous systems is too large, such as when the system iterates for every feature, or every combination of features. It should be noted that the term “feature” could also be referred as “variable,” “covariate”, “attribute”, or any similar term.

The quality of a model (i.e., determined by calculating metrics such as prediction accuracy, calibration, or fairness-related) can depend on the selected features that are represented in the model's training data. In particular, some features may be highly correlated to the outcome, some features may be weakly correlated, and some features may be entirely irrelevant to outcome. Some features may be highly correlated to the outcome, but may be also correlated with each other, thus being possibly redundant. In general, a model that is trained on relevant features should be able to forecast an outcome more accurately than a model that is trained using extra irrelevant features or redundant features. As such, an objective of feature selection is to select a small number of relevant features. In addition, the interpretability of a model becomes more difficult as the number of features used to generate the model increases. Furthermore, some features may be difficult to acquire (e.g., by high cost or by time), and if found to be non-informative or redundant, a model can benefit by not relying on such features. Other features may be easier to acquire (e.g., age, gender, comorbidities stored in the patient's historical profile), and reliance on relevant features that are cheaper and/or easy to acquire can improve forecasting for less cost. In the following example systems, a propensity score matching process is applied to match an outcome relative to relevant features, and an iterative enhanced feature selection is performed in order to reduce the number of features used to train a model without negatively impacting the model's accuracy. In one embodiment comparison of features is based on applying standard statistical tests. Any data-related application, including such use cases as health care, user analytics, commerce, finance, and the like, may benefit from an increase in performance realized by the disclosed systems. Moreover, embodiments of the disclosed system increase processing efficiency by reducing the number of iterations required to identify top informative features that are processed by a predictive model, thereby reducing the total number of computational operations required to forecast an outcome.

Various embodiments of the disclosed system will now be discussed. In some embodiments, the predictive model is applied to predict outcomes. Thus, outcomes can be predicted more efficiently while ensuring the accuracy of forecasted outcomes. In some embodiments, a selection score is determined for each feature of the plurality of features, wherein the selection score corresponds to a number of case-control subsets in which the statistical significance of the feature satisfies a significance threshold value, and the plurality of features are ranked by selection score to select the final subset of features having selection scores that satisfy a selection threshold value. By selecting features that are the most statistically significant different across a variety of matched case-control subsets, embodiments of the disclosed system ensure that a model is trained on features most likely to be highly relevant to outcome. In some embodiments, the significance of different types of features can be compared to a threshold. Statistical significance of each feature not used for matching could then be compared to the threshold. Statistical significance for a feature depends on its type, which may be, for example, categorical (e.g., yes/no, multiple textual values), continuous (numerical) that may be normally distributed, and continuous features not normally distributed. The threshold me be determined in advance (e.g., 0.001) or be calculated dynamically and change from one iteration to another. In some embodiments, the selection threshold value comprises a percentage of features in each case-control subset in which the statistical significance of the feature satisfies the significance threshold value. Thus, features that are significant to outcome in a large number of case-control subsets can be identified, improving feature selection robustness. In some embodiments, the predictive model is evaluated against a reference model to validate accuracy of the predictive model, wherein the reference model is trained using the dataset. By evaluating a predictive model's performance, embodiments of the disclosed system can ensure that the model's predictions are more accurate in comparison with commonly used feature selection methods. In some embodiments, randomly selected case-control subsets are matched according to propensity score matching with a caliper value and a case-control ratio value until a convergence has occurred, with the convergence indicating that further iterations will not significantly alter the ranking of features. Thus, feature selection is achieved in less iterations than would be required in systems where every subset is evaluated.

It should be noted that references throughout this specification to embodiments, advantages, or similar language herein do not imply that all of the embodiments and advantages that may be realized with the embodiments disclosed herein should be, or are in, any single embodiment of the invention. Nor does omission of certain embodiments, advantages, or similar elements from one disclosed embodiment imply that such embodiments, advantages or similar elements cannot be achieved by such embodiment. Rather, language referring to the embodiments and advantages is understood to mean that a specific feature, advantage, or characteristic described in connection with an embodiment is included in at least one embodiment of the present invention. Thus, discussion of the embodiments, advantages, and similar language, throughout this specification may, but do not necessarily, refer to the same embodiment.

Furthermore, the described embodiments, advantages, and characteristics of the invention may be combined in any suitable manner in one or more embodiments regardless of whether or not the specific combination is expressly defined herein. One skilled in the relevant art will recognize that the invention may be practiced without one or more of the specific embodiments or advantages of a particular embodiment. In other instances, additional embodiments and advantages may be recognized in certain embodiments that may not be present in all embodiments of the invention.

These embodiments and advantages will become more fully apparent from the following drawings, description and appended claims, or may be learned by the practice of embodiments of the invention as set forth hereinafter.

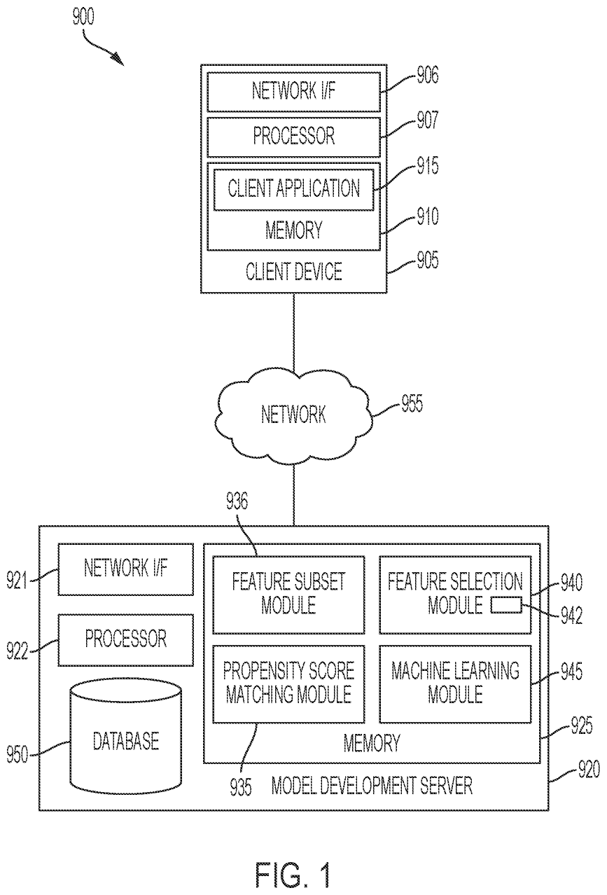

Embodiments of the system disclosed herein will now be described in detail with reference to the Figures. FIG. 1 is a block diagram depicting a computing environment 900 for model development in accordance with an embodiment of the present invention. As depicted, computing environment 900 includes a client device 905, a model development server 920, and a network 955. It is to be understood that the functional division among components of computing environment 900 have been chosen for purposes of explaining embodiments of the system disclosed herein and is not to be construed as a limiting example.

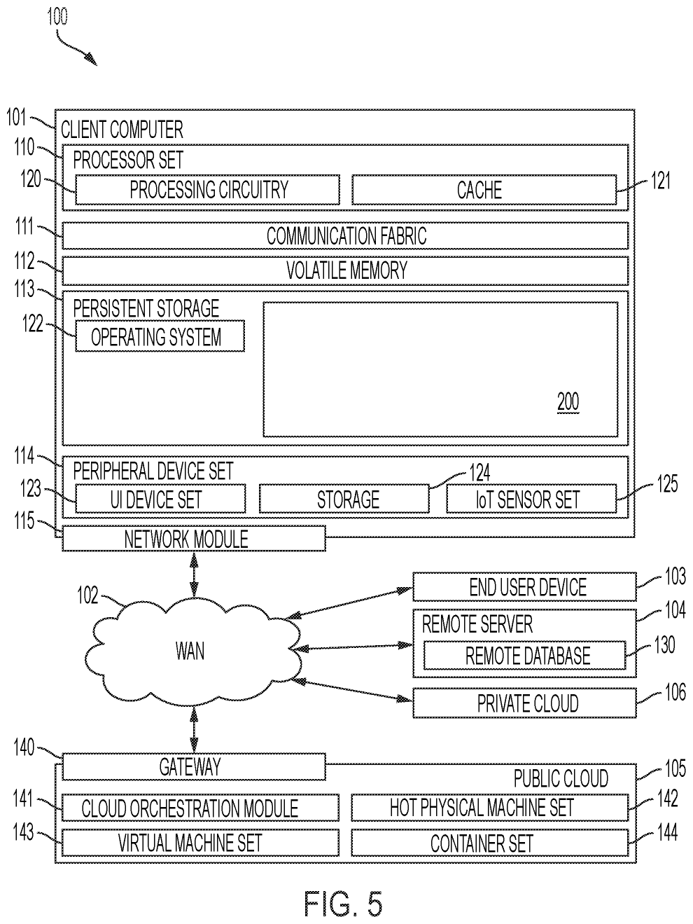

Client device 905 includes a network interface (I/F) 906, at least one processor 907, and memory 910 that includes a client application 915. Client device 905 may include a laptop computer, a tablet computer, a netbook computer, a personal computer (PC), a desktop computer, a personal digital assistant (PDA), a smart phone, a thin client, or any programmable electronic device capable of executing computer readable program instructions. Network interface 906 enables components of client device 905 to send and receive data over a network, such as network 955. In general, client device 905 enables a user to perform, at model development server 920, model development operations, including feature selection, model training and testing, subpopulation analysis, and/or other tasks in accordance with embodiments of the system disclosed herein. Client device 905 may include internal and external hardware components, as depicted and described in further detail with respect to FIG. 5.

Client application 915 may include one or more modules or units to perform various functions of embodiments of the system disclosed herein and described below. Client application 915 may be implemented by any combination of any quantity of software and/or hardware modules or units, and may reside within memory 910 of client device 905 for execution by a processor, such as processor 907.

Client application 915 may send instructions to model development server 920 to perform one or more operations related to data modeling. A user of client application 915 can provide one or more datasets to model development server 920 by uploading datasets or otherwise indicating locations of local and/or network-accessible datasets. Client application 915 may enable a user to submit a model development request, which can specify feature selection algorithms, machine learning algorithms, statistical techniques used to measure performance of data models, acceptable ranges of input values used to identify subpopulations, and the like. Additionally or alternatively, a user of client device 905 may, via client application 915, select trained models and apply selected models to various data processing tasks.

Model development server 920 includes a network interface (I/F) 921, at least one processor 922, and memory 925. Memory 925 may include a feature subset module 930, a propensity score matching module 935, a feature selection module 940, and a machine learning module 945. Model development server 920 may include a laptop computer, a tablet computer, a netbook computer, a personal computer (PC), a desktop computer, a personal digital assistant (PDA), a smart phone, a thin client, or any programmable electronic device capable of executing computer readable program instructions. Network interface 921 enables components of model development server 920 to send and receive data over a network, such as network 955. In general, model development server 920 and its modules develop models using enhanced feature selection techniques, and apply developed models to data processing tasks in accordance with embodiments of the system disclosed herein. Model development server 920 may include internal and external hardware components, as depicted and described in further detail with respect to FIG. 5.

Feature subset module 930, propensity score matching module 935, feature selection module 940, and machine learning module 945 may include one or more modules or units to perform various functions of embodiments of the system described below. Feature subset module 930, propensity score matching module 935, feature selection module 940, and machine learning module 945 may be implemented by any combination of any quantity of software and/or hardware modules or units, and may reside within non-transitory computer readable memory 925 of model development server 920 for execution by a processor, such as processor 922.

Feature subset module 930 processes an input dataset containing features and outcomes to identify different subsets of features for use in subpopulation analysis. A dataset may include a plurality of records that each include values for various features and outcomes. Each feature, also referred to as a covariate or variable or attribute, includes a value that describes a record in some manner. For example, a clinical dataset may include features of age, gender, disease status, laboratory observation, administered medication status, and the like, along with an outcome of interest. Additionally or alternatively, features can be extracted from clinical narrative notes using conventional or other natural language processing techniques. Thus, each record in the clinical dataset includes values for the features that together describe a patient. Additionally, each record specifies a binary outcome (e.g., “recovered” or “not recovered”). Records that include true values (e.g., “1”) for the outcome of interest are referred to as cases, and records that include false values (e.g., “0”) for the outcome of interest are referred to as controls. In some embodiments, a dataset may be arranged as a tabular two-dimension data frame. For example, a set of clinical data that describes 43,000 patients in terms of 199 features may have 200 columns (one for each of the 199 features, and one indicating an outcome) and 43,000 rows (each of which includes a single patient's values for the 199 features and an outcome).

Feature subset module 930 identifies different subsets of features by randomly assigning features to subsets. The number of features that feature subset module 930 assigns to a given subset may be predetermined or defined by some input parameter, which can be provided by a user of client device 905. In some embodiments, a subset's number of features may be much smaller than the overall number of features of a dataset. For example, in a dataset containing 999 features, each subset may include ten features. In some embodiments, feature subset module 930 assigns features to subsets using an exhaustive approach until all of a dataset's features are assigned. For example, in a dataset of 999 features and an outcome, ten features may be selected at random out of the 999 for a first subset, another ten features may be randomly selected out of the remaining 989 features, etc. In some embodiments, features are randomly selected out of the entire available set of features, resulting in different subsets that may share one or more features in common. Feature subset module 930 generates subsets of features for the iterative process until a point of convergence has been achieved.

Propensity score matching module 935 applies one or more propensity score matching techniques to a dataset to identify, for each subset of features, a subset of cases and controls that are similar in terms of their values for the subset of features. In particular, propensity score matching module 935 identifies case-control subsets by applying propensity score matching and filtering results using a caliper value and a case-control ratio value. The propensity score matching is based on the outcome variable and on the subset of features selected by feature subset module 930. In particular, a propensity score can be calculated for a set of features of a record with respect to the outcome, and caliper values and case-control ratio values are used to filter the results to identify matchings. The propensity score for a particular record is defined as the conditional probability of the outcome given the record's feature values. A caliper value is a numerical value that is multiplied with a standard deviation for a selected case value to define a range of acceptable control values that can be matched with the case. Equations (1) and (2) define the minimum and maximum values that a control must have to be matched to a case for each covariate used for matching.

$$Minimum control value = ( case value ) - ( caliper value ) \times ( standard deviation of value for cases ) \qquad ( 1 )$$

$$Maximum control value = ( case value ) - ( caliper value ) \times ( standard deviation of value for cases ) \qquad ( 2 )$$

For example, for a feature of patient age, if a control has a value of 72 years and the standard deviation of control age values in the dataset is 10 years, then a caliper value of 0.25 indicates that the control may be matched with a case if the control has an age value of 72 years±0.25×10 years. Thus, the age of a selected control must be between 69.5 years and 74.5 years.

Propensity score matching module 935 may apply a same caliper value to all of the feature values for a given case record in order to find a control record having corresponding feature values that are all acceptable. Thus, if a dataset does not contain any control record that matches a case on all feature values, then the case may be dropped from consideration. Propensity score matching module 935 may apply caliper values and case-control ratio values that are predefined or user-defined.

Thus, propensity score matching module 935 identifies a case-control subset for each feature subset, with each case-control subset containing both cases and controls that share similar values for features of the corresponding feature subset, but have different outcomes (as cases have different outcomes from controls by definition). Each case-control subset identified by propensity score matching module 935 is processed by feature selection module 940 to select features, which are used by machine learning module 945 to train and evaluate a model using the selected features.

Feature selection module 940 analyzes values of features of each case-control subset to identify features that are associated with the outcome in a statistically significant manner. Specifically, while a case-control subset includes cases and controls that have very similar values for the subset of features used to match those cases and controls, feature selection module 940 analyzes values of cases and controls for the features that were not included in the subset of features. For example, if a case-control subset contains records that are matched according to a subset of ten particular features, and a dataset has 999 features overall, existing systems will use the feature selection module 940 to analyze the values for the remaining 989 features in order to identify features that are relevant to distinguishing the difference in outcome between cases and controls.

Feature selection module 940 applies univariate analysis to each feature that was not used for matching in order to determine the statistical significance of each feature with respect to forecasting outcome. Feature selection module 940 may represent statistical significance by computing a probability value (p-value) for each feature. In various embodiments, feature selection module 940 applies a chi-square test for features having categorical variables, applies a t-test for features having normally-distributed variables, and applies a non-parametric test for features having continuous variables that are not normally distributed.

Once feature selection module 940 determines p-values for each feature of a case-control subset, excluding the features used to match cases to controls, feature selection module 940 may rank the features according to p-value. Feature selection module 940 may determine whether each feature of a case-control subset has a p-value that satisfies a predetermined significance threshold. For example, feature selection module 940 may identify features having a p-value of less than 0.001. Feature selection module 940 may assign a selection score for each feature that corresponds to the number of case-control subsets in which the feature's p-value satisfies the significance threshold. For example, feature selection module 940 may assign a single point to a feature's selection score for every instance of the feature's p-value that satisfies a significance threshold in a given case-control subset.

In embodiments of the system described herein, the feature selection module 940 includes a convergence submodule 942. In general, the convergence submodule 942 monitors the iterations of the feature selection module 940, and determines that a sufficient feature selection has been completed once a variability criteria is addressed. A variability measure below the threshold is referred to in such embodiments as the method has converged. In alternative embodiments, convergence may be defined by a threshold number of remaining features (e.g., less than 25% of the initial features remaining), or may be defined by a set number of sequential iterations without a reduction in the number of rewarded features.

When feature selection module 940 has processed all of the case-control subsets to obtain selection scores for each feature in a dataset, the features may be ranked according to selection score, and a final subset of features may be selected for training a model. In some embodiments, feature selection module 940 compares the selection scores of each feature to a selection threshold value, and selects all features that satisfy the selection threshold value. In some embodiments, feature selection module 940 selects a predefined number of features having the highest selection scores. In some embodiments, feature selection module 940 selects features whose selection scores are at or above a particular percentile (e.g., a top 5% of features).

Machine learning module 945 trains data models, using the values of selected features, to perform outcome forecasting. Machine learning module 945 may train a data model using the features selected by feature selection module 940 once converged according to convergence submodule 942 to forecast outcomes. Machine learning module 945 may train models using the selected feature values for all records of a dataset, or may train models using the selected feature values for a subpopulation of a dataset. Machine learning module 945 may apply conventional or other machine learning techniques to train models. In some embodiments, machine learning module 945 utilizes logistic regression, a neural network, or a foundation model, to train a predictive model.

Machine learning module 945 may evaluate trained models to measure and compare the accuracy of models. In particular, machine learning module 945 may test a model by applying the model to a testing set of records to compare outcomes forecasted by the model to the actual outcomes. A dataset used to train a model may also be used to test the model. For example, 67% of the cases and controls of a dataset may be used to train a model, and the remaining 33% may be reserved for subsequently testing the model. When a dataset is divided into a testing set and a training set, individual records may be randomly assigned to one set or the other in a manner that preserves the overall ratio of cases and controls.

In some embodiments, machine learning module 945 measures a model's performance by identifying the true positives and false positives at various discrimination threshold levels. A discrimination threshold defines the threshold for an output probability value to be considered a positive. For example, if a discrimination threshold is 0.5, then a probability value of 0.6 that is returned by a model is considered a positive, and a probability value of 0.4 is considered a negative. Thus, a discrimination threshold of, for example, 0.1, would be expected to return more false positives than a discrimination threshold of 0.5 for a given model.

The true positives and false positives for various discrimination thresholds are used to construct a receiver operating characteristic curve for a model. A receiver operating characteristic curve is a graphical plot of true positives against false positives at various discrimination thresholds. An area under the curve (AUC) of a receiver operating characteristic curve can then be computed by machine learning module 945. In general, an AUC is equal to the probability that the tested model will rank a randomly chosen positive instance higher than a randomly chosen negative one (assuming positive instances rank higher than negative instances). Inputs and/or outputs of machine learning module 945 may be normalized such that AUC values calculated by machine learning module 945 range between 0 and 1. An AUC of 0.5 may indicate that the case and control values upon which a model is trained are so similar to each other that the resulting trained model cannot discriminate cases from controls, whereas an AUC of 1.0 may indicate that the two groups can be perfectly distinguished by the model. Thus, a predictive model that has a higher AUC value is more accurate than a model having a lower AUC value. It should be appreciated that AUC values can be computed directly using inputs of true positives and corresponding false positives at two or more discrimination threshold levels; thus, it is unnecessary to generate a graphical plot of a receiver operating characteristic curve. Rather, any mathematical technique for approximating definite integrals can be applied to calculate AUC values. For example, trapezoidal rule approximation or Riemann sum approximation can be used to calculate AUC values.

An AUC value of a model trained using features selected according to a present invention embodiment can be compared to one or more models trained using other feature selection techniques in order to compare the performance of each model. For example, a model trained using features selected by feature selection module 940 can be compared to a reference model that is trained on the same dataset but whose features are selected using another technique, such as a random forest feature selection method or a least absolute shrinkage and selection operator (LASSO) method.

Database 950 may include any non-volatile storage media known in the art. For example, database 950 can be implemented with a tape library, optical library, one or more independent hard disk drives, or multiple hard disk drives in a redundant array of independent disks (RAID). Similarly, data in database 950 may conform to any suitable storage architecture known in the art, such as a file, a relational database, an object-oriented database, and/or one or more tables. In some embodiments, database 950 may store data related to model development, including input datasets, training datasets, testing datasets, and resulting trained models.

Network 955 may include a local area network (LAN), a wide area network (WAN) such as the Internet, or a combination of the two, and includes wired, wireless, or fiber optic connections. In general, network 155 can be any combination of connections and protocols known in the art that will support communications between client device 905 and model development server 920 via their respective network interfaces in accordance with embodiments of the present invention.

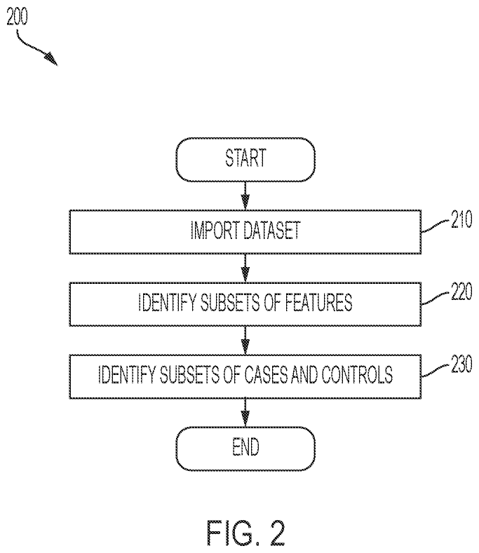

FIG. 2 is a flow chart depicting a method 200 of matching cases and controls in accordance with an embodiment of the present invention.

A dataset is imported at operation 210. Feature subset module 930 may import a dataset from database 950, or client application 915 may provide feature selection module 930 with a dataset. The imported dataset may include records with values indicated for each feature (e.g., “age,” “gender,” “blood type,” etc.), as well as an outcome of interest for a model being trained (e.g., “not recovered” or “recovered”). Cases may include any records that include true values for the outcome, and controls may include any records that include false values for the outcome.

Subsets of features are identified at operation 220. Feature subset module 930 may identify different subsets of features by randomly assigning features of the dataset into subsets. The number of features that feature subset module 930 assigns to a given subset may be predetermined or defined by a predetermined or user-indicated value. Features may be randomly selected from a dataset's entire set of features for every subset, or a feature may be removed from the pool of assignable features when the feature is assigned to a subset.

Case-control subsets are identified at operation 230. Given a subset of features, propensity score matching module 935 may match cases in an input dataset with controls whose values for the subset of features are similar. Propensity score matching module 935 may select a control whose value for a given feature falls within an acceptable range of a case's value for the feature, which can be defined according to a caliper value multiplied by a standard deviation of the feature among cases. Propensity score matching module 935 matches controls to cases according to a proportion indicated by a provided case-control ratio value.

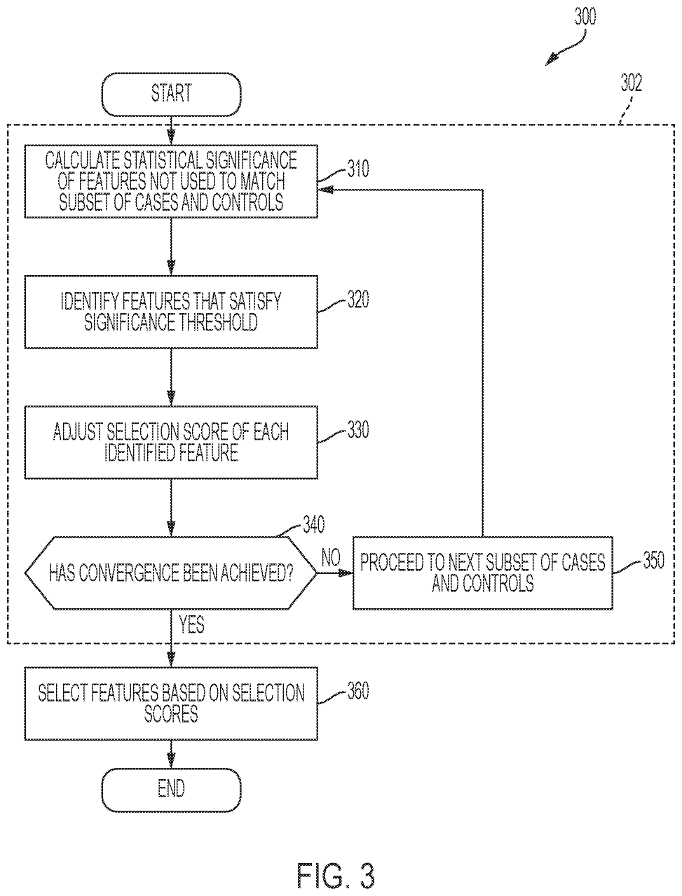

FIG. 3 is a flow chart depicting a method 300 of selecting features in accordance with an embodiment. The method 300 uses a convergence criteria to determine when iterations are ceased.

A case-control subset is analyzed to calculate the statistical significance of features that were not used to match cases to controls for the selected case-case subset at operation 310. The statistical significance of a feature is determined with respect to the feature's probability of being correlated with an outcome. Feature selection module 940 may compute a p-value for each feature of a case-control subset, excluding the features used to match the records of the case-control subset.

Features of a case-control subset whose statistical significance satisfy a significance threshold are identified at operation 320. Feature selection module 940 may compare a probability value (p-value) of a feature to a predetermined threshold to identify features that are particularly significant. For example, feature selection module 940 may identify a feature when the feature's p-value is less than 0.001, less than or equal to 0.05, and the like.

A selection score for each identified feature is adjusted at operation 330. Each feature that is identified using the significance threshold may be noted by increasing a value of the feature's selection score. For example, a point may be rewarded to a feature every time that the feature is identified as significant in a particular case-control subset.

Operation 340 determines whether the results of the process 300 have converged on a desirable feature set. To make the determination, operation 340 computes a pairwise reward distance for each feature, adds the pairwise reward distance to a cumulative distance, to compute a cumulative reward for each feature, and evaluates whether the features have converged based on the cumulative rewards.

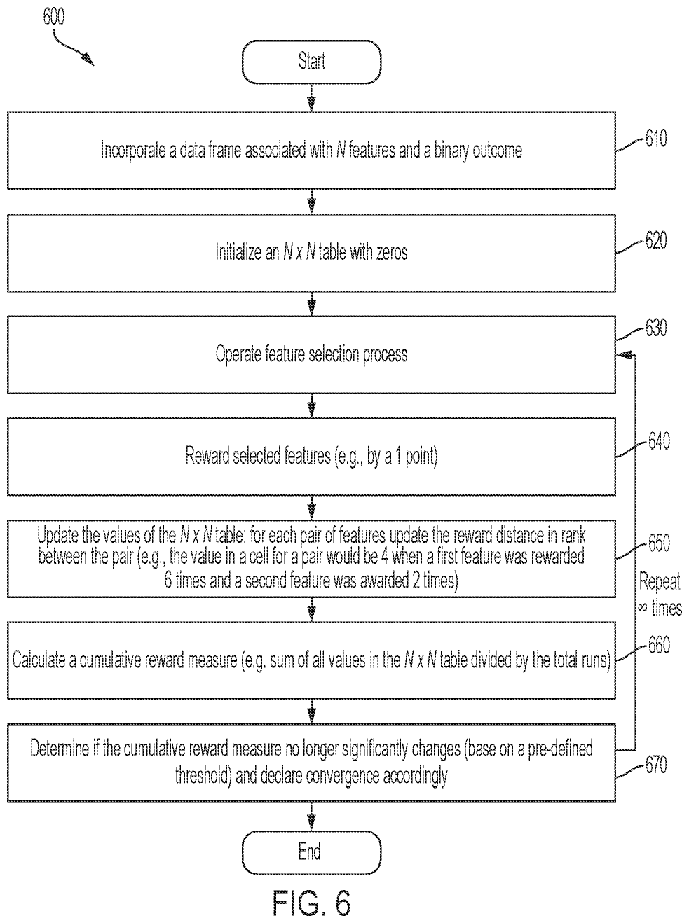

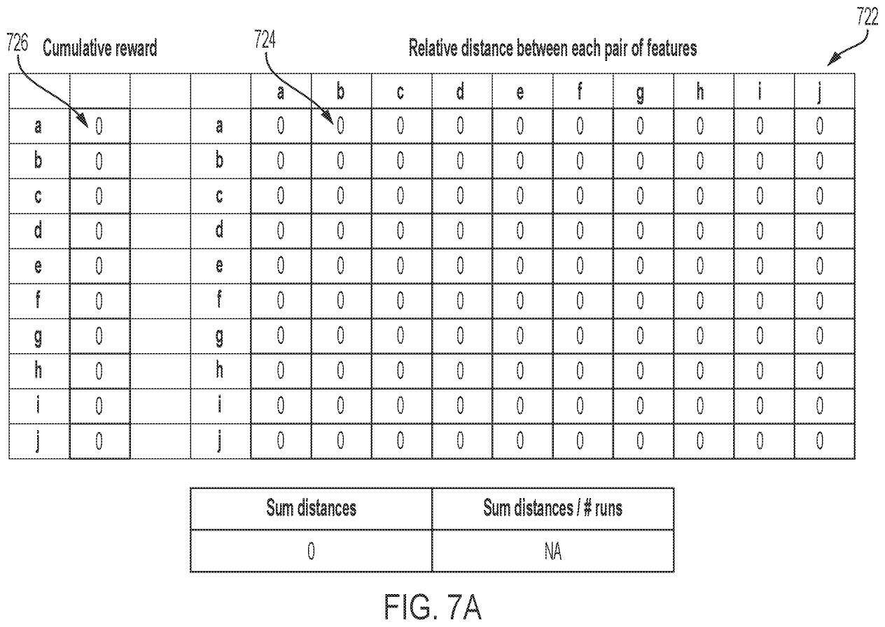

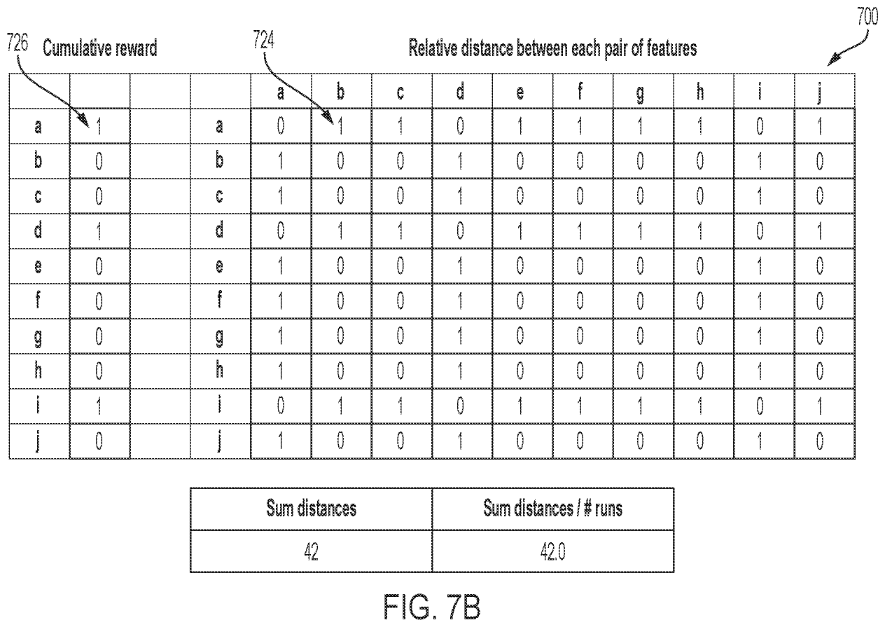

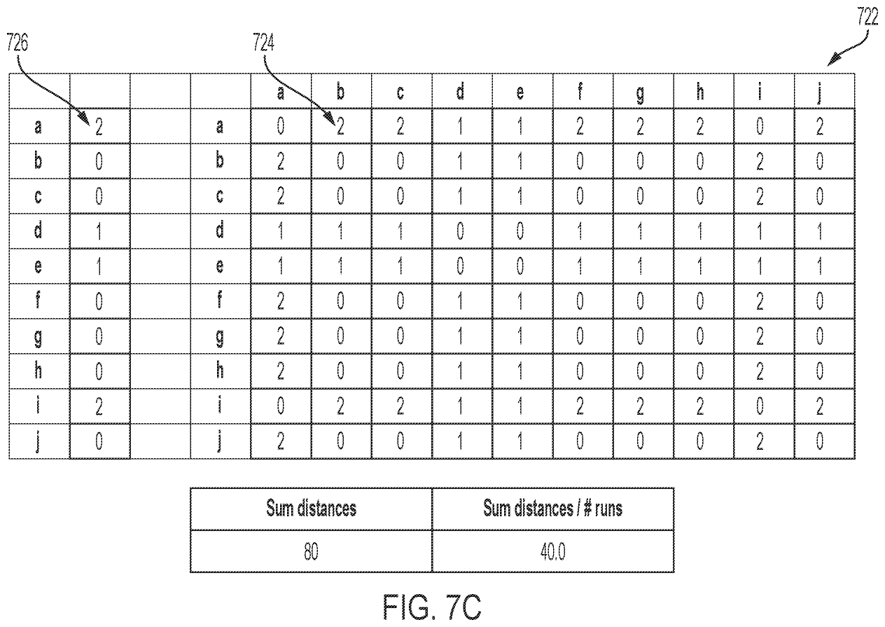

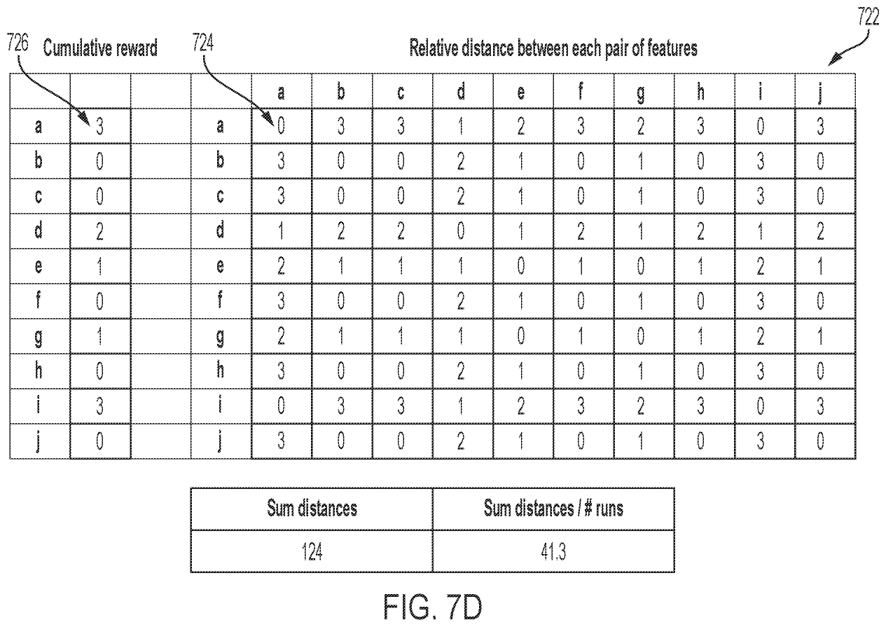

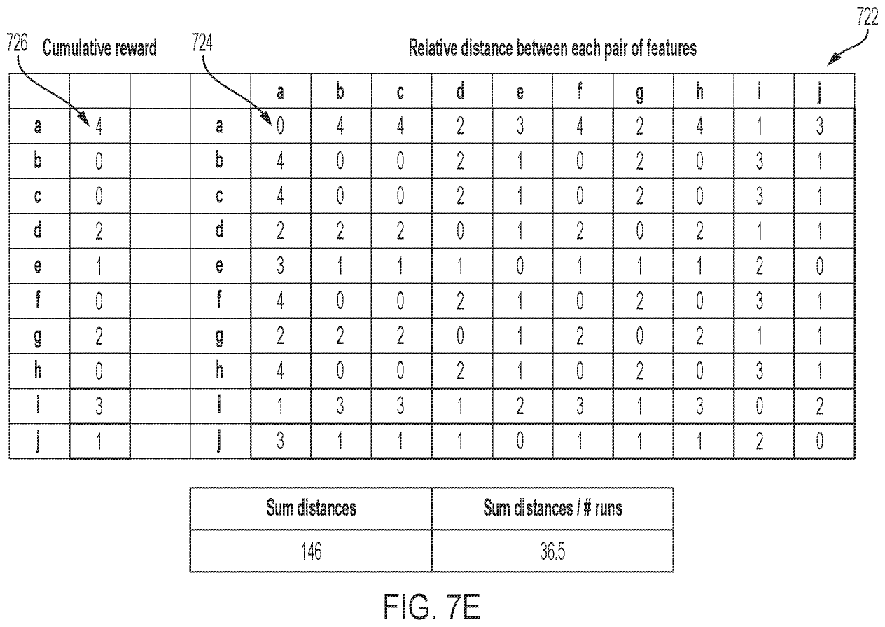

Operations 310, 320, 330 and 340 are utilized within a convergence process 302, and described in greater detail, at FIG. 6. Initially the convergence process 600 incorporates a data frame with a number N features (e.g., 100 features) with a determined binary outcome in an operation 610. An N×N table 722 (FIG. 7A-7E) is initialized, with a distance value for each pairing of features set at 0 in an initialization operation 620 (FIG. 7A). The table 722 is updated with each successive iteration such that FIG. 7B corresponds to the first iteration, FIG. 7C corresponds to the second iteration, FIG. 7D corresponds to the third iteration, and FIG. 7E corresponds to the fourth iteration. The exemplary N×N table includes 10 features (a-j), although it is appreciated that practical applications may have substantially more features and 10 features is used in the example for ease of understanding.

Once the N×N table 722 has been initialized, a feature selection process is performed in operation 630. In one example, the feature selection process is the process identified at operations 310, 320, 330 of FIG. 3, although in alternative examples, alternative feature selection processes can be operated in the same capacity. The feature selection process determines a normalized relative correlation distance between each selected feature a-j and each other feature a-j, and records the distance between each pair of features for that iteration in the relative distance entry 724 corresponding to the pair. Features meeting the selection criteria (e.g. more than X other features with a distance greater than 0) are awarded a reward in the cumulative reward 726 for that feature in an operation 640. In the illustrated example, the award is a constant value of 1. In alternate examples, the reward can be variable, with the magnitude of the reward being dependent on the type of feature, dependent on the number of iterations (a predefined number or total) and/or a function of the number of selected features (a predefined number or total). Features can be categorical, binary, continuous, time-to-event, interaction features or a combination of these. Binary features are features that have only two possible values. Examples of binary features include variables such as gender (male/female), vaccination status (vaccinated/not vaccinated), and presence/absence of a disease or condition. Categorical features are features that have more than two possible values. Examples of categorical features include variables such as race/ethnicity (e.g., White, Black, Hispanic), educational level (e.g., less than high school, high school graduate, college degree), and occupation (e.g., healthcare worker, construction worker, teacher). Continuous features are features that can take any numerical value within a range. Examples of continuous features include variables such as age, body mass index (BMI), blood pressure, and cholesterol level. Time-to-event features are features that measure the time from a particular event (such as diagnosis or treatment) to a subsequent event (such as death or recurrence). These features are often analyzed using survival analysis methods. Interaction features are features that represent the interaction between two or more variables. For example, an interaction feature might represent the combined effect of smoking status and alcohol consumption on the risk of developing a particular disease.

In addition, the values of the N×N table 600 are updated such that for each pair of features, the reward distance is updated in rank between the pair (e.g., values in a cell for a pair would be 4 when a first feature of the pair is rewarded 6 times, and a second feature is awarded 2 times). The reward distance is the difference between the total award of each pair of features. The table is updated in operation 650, after which a cumulative reward measure 726 is calculated for each feature. The cumulative reward in the illustrated example is the sum of all values in the N×N table 600 divided by the number of iterations (a predefined number or total) in an operation 660.

After determining the cumulative reward measure, the process 600 determines if the cumulative reward measure has not significantly changed from a previous iteration, or iterations in an operation 670. The magnitude of the change that constitutes a “significant change” is dependent on the particular operation and can be set by one of skill in the art. In some examples, the change is compared to the single immediately prior iteration. In other examples, the change is compared to a moving average of a set number of prior iterations (e.g., the last 5 iterations). Comparing the change to the running average allows the process to identify a convergence while at the same time minimizing, or eliminating, detections that may occur due to the selection of newly (but rare) discovered features in each iteration.

When the comparison determines that the cumulative reward measure is not significantly different from the previous iteration or iterations, the iterations are ceased and the process 600 ends, progressing the process to operation 360 of FIG. 3.

When the feature selection operations 310, 320, 330 have reached convergence, as determined at operation 340 and described in greater detail with regard to FIGS. 6 and 7A-7E, a final set of features is selected based on the selection scores at operation 360. In some embodiments, feature selection module 940 compares the selection scores of each feature to a selection threshold value, and selects any features that satisfy the selection threshold value. In some embodiments, feature selection module 940 selects a predefined number of features having the highest selection scores. In some embodiments, feature selection module 140 selects features whose selection scores are at or above a particular percentile.

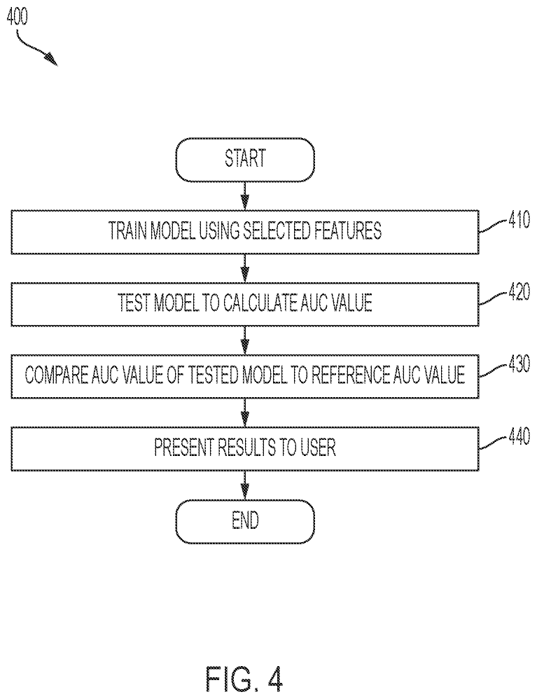

FIG. 4 is a flow chart depicting a method 400 of evaluating model performance in accordance with an embodiment of the present invention.

A model is trained using selected features at operation 410. The model may be trained to forecast outcomes using conventional or other machine learning techniques. In particular, the model is trained using the final set of features selected in accordance with a present invention embodiment (e.g., the set of features selected using method 300 considering convergence criteria was addressed). The model may be trained using training data extracted from the same dataset that is used for feature selection. In various embodiments, models may include any conventional or other logistical regression models.

The model is tested to calculate an AUC value at operation 420. A testing set of data, which may also be extracted from the same dataset used to train the model, may be processed by the model to identify false positives and true positives across various discrimination thresholds. Machine learning module 945 may then calculate the area under a receiver operating characteristic curve corresponding to the false positives and true positives.

The AUC value of the tested model is compared to a reference AUC value at operation 430. The reference AUC value may be computed similarly to the AUC value of the tested model using a different model. If the AUC values are close, then the tested model's accuracy is approximately the same as the reference model's accuracy. If the AUC value of the tested model is higher than the reference AUC value, then the tested model may forecast outcomes more accurately than the reference model. Thus, when a tested model uses fewer features than the reference model, and both models have comparable AUC values, then the tested model demonstrates superior efficiency and should be recommended over the reference model.

Results of testing the model are presented to a user at operation 440. Results may be transmitted to client device 905 for review by a user, and may include a summary of the tested model's performance against one or more other models. Thus, a user may select a test model when the test model demonstrates acceptable accuracy and efficiency. The selected model may then be provided with input data and applied to forecast outcomes. The model with fewer features may be automatically selected and utilized to generate outcomes, thus saving computing resources while identifying outcomes at an acceptable or improved level of accuracy.

FIG. 5 is a block diagram depicting components of a computer environment 100 suitable for executing the methods disclosed herein. Computing environment 100 contains an example of an environment for the execution of at least some of the computer code involved in performing the inventive methods, such as [Fill in this space with the name of the inventive code block. This description should reveal to the reader what the inventive code does at a general level. Illustrative examples: “improved cloud orchestration code,” “new ML algorithm code,” etc.] 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The various functions of the computer or other processing systems may be distributed in any manner among any number of software and/or hardware modules or units, processing or computer systems and/or circuitry, where the computer or processing systems may be disposed locally or remotely of each other and communicate via any suitable communications medium (e.g., LAN, WAN, Intranet, Internet, hardwire, modem connection, wireless, etc.). For example, the functions of the embodiments of the system disclosed herein may be distributed in any manner among the various end-user/client and server systems, and/or any other intermediary processing devices. The software and/or algorithms described above and illustrated in the flowcharts may be modified in any manner that accomplishes the functions described herein. In addition, the functions in the flowcharts or description may be performed in any order that accomplishes a desired operation.

The software of the embodiments of the system disclosed herein (e.g., communications software, server software, client application 115, feature subset module 130, propensity score matching module 135, feature selection module 140, machine learning module 145, etc.) may be available on a non-transitory computer useable medium (e.g., magnetic or optical mediums, magneto-optic mediums, floppy diskettes, CD-ROM, DVD, memory devices, etc.) of a stationary or portable program product apparatus or device for use with stand-alone systems or systems connected by a network or other communications medium.

The communication network may be implemented by any number of any type of communications network (e.g., LAN, WAN, Internet, Intranet, VPN, etc.). The computer or other processing systems of the embodiments of the system disclosed herein may include any conventional or other communications devices to communicate over the network via any conventional or other protocols. The computer or other processing systems may utilize any type of connection (e.g., wired, wireless, etc.) for access to the network. Local communication media may be implemented by any suitable communication media (e.g., local area network (LAN), hardwire, wireless link, Intranet, etc.).

The system may employ any number of any conventional or other databases, data stores or storage structures (e.g., files, databases, data structures, data or other repositories, etc.) to store information (e.g., data relating to improving the computerized processing of data models by using a reduced quantity of features while maintaining accuracy). The database system may be implemented by any number of any conventional or other databases, data stores or storage structures (e.g., files, databases, data structures, data or other repositories, etc.) to store information (e.g., data relating to improving the computerized processing of data models by using a reduced quantity of features while maintaining accuracy). The database system may be included within or coupled to the server and/or client systems. The database systems and/or storage structures may be remote from or local to the computer or other processing systems, and may store any desired data (e.g., data relating to improving the computerized processing of data models by using a reduced quantity of features while maintaining accuracy).

The embodiments of the system disclosed herein may employ any number of any type of user interface (e.g., Graphical User Interface (GUI), command-line, prompt, etc.) for obtaining or providing information (e.g., data relating to improving the performance of data models by enhancing feature selection using sub-population analysis), where the interface may include any information arranged in any fashion. The interface may include any number of any types of input or actuation mechanisms (e.g., buttons, icons, fields, boxes, links, etc.) disposed at any locations to enter/display information and initiate desired actions via any suitable input devices (e.g., mouse, keyboard, etc.). The interface screens may include any suitable actuators (e.g., links, tabs, etc.) to navigate between the screens in any fashion.

The embodiments of the system disclosed herein are not limited to the specific tasks or algorithms described above, but may be utilized for any number of applications in any relevant fields, including, but not limited to, processing various sets of data to develop models having improved computerized processing performance.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising”, “includes”, “including”, “has”, “have”, “having”, “with” and the like, when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer-implemented method for training a predictive model comprising using a dataset of features and an outcome:
(A) generating a table for a dataset comprising a plurality of features, the table containing numerical values for each pair of features in the dataset;
(B) randomly selecting the plurality of features from the dataset, thereby creating a first subset of features;
(C) operating a propensity score matching using the randomly selected plurality of features to identify a subset of cases and controls using the outcome variable;
(D) rewarding one or more features of a second subset of features consisting of features in the plurality of features that were not selected randomly, each feature of the second subset addresses a statistical significance criteria;
(E) updating each entry in the table with a reward distance between each pair of features;
(F) calculating a cumulative reward measure;
(G) iterating steps (B)-(F) until a convergence criteria is met;
(H) selecting a final subset of features when a variability criteria of the cumulative reward measure addresses the convergence criteria; and
(I) training the predictive model using the final subset of selected features.

2. The computer-implemented method of claim 1, wherein the feature selection process comprises:
matching cases and controls to select a plurality of case-control subsets for the first subset of features, each case-control subset having similar values for the corresponding randomly selected subset of features; and
identifying, for each case-control subset, a plurality of features absent from the subset of features used to match the case-control subset, in which such features of the second subset of features address a statistical significance criteria.

3. The computer-implemented method of claim 1, wherein the cumulative reward measure is a sum of all values in the table divided by a number of iterations.

4. The computer-implemented method of claim 3, wherein the convergence criteria is met based on a deviation of a calculated cumulative reward measure of the current iteration from an immediately prior calculated cumulative reward measure being less than a predetermined threshold.

5. The computer-implemented method of claim 3, wherein the convergence criteria is met based on a deviation of a calculated cumulative reward measure of the current iteration from a moving average cumulative reward measure of an immediately previous set of iterations being less than a predetermined threshold.

6. The computer-implemented method of claim 1, wherein rewarding one or more features of the second subset of features comprises rewarding each feature that addresses a statistical significance threshold in the second subset of features by a constant value.

7. The computer-implemented method of claim 1, wherein rewarding one or more features of the second subset of features comprises rewarding each feature that addresses a statistical significance threshold in the second subset of features by a variable value, wherein the variable value is a function of at least one of a type of feature, a number of iterations, and a number of selected features.

8. The computer-implemented method of claim 1, further comprising applying the predictive model to predict outcomes.

9. The computer-implemented method of claim 1, wherein selecting subset of features comprises:
selecting a case-control ratio value to determine the total number of controls to identify per case; and
selecting a caliper value to identify a subset of controls associated with features of similar values to the features of the cases.

10. The computer-implemented method of claim 1, further comprising:
determining a final list of selected features when convergence criteria is met, each feature in the list of final list of features received a positive reward.

11. The computer-implemented method of claim 1, further comprising:
evaluating the predictive model against a reference model to validate accuracy of the predictive model using the final subset of selected features, wherein the predictive model and the reference models are trained using the dataset.

12. A computer system for training a predictive model, the computer system comprising:
one or more computer processors;
one or more computer readable storage media;
program instructions stored on the one or more computer readable storage media for execution by at least one of the one or more computer processors, the program instructions comprising instructions using a dataset of features and an outcome to:
(A) initiating a table for a dataset comprising a plurality of numerical values for each pair of features;
(B) randomly selecting a plurality of features from the dataset, thereby creating a first subset of features;
(C) operating a propensity score matching on the dataset using the randomly selected plurality of features, to identify a subset of cases and controls using the outcome variable;
(D) rewarding one or more features of a second subset of features consisting of features in the plurality of features that were not selected randomly when each addresses a statistical significance criteria;
(E) updating each entry in the table with a reward distance between each pair of features;
(F) calculating a cumulative reward measure;
(G) iterating steps (B)-(F) until a convergence criteria is met;
(H) selecting a final subset of features when a variability criteria of the cumulative reward measure addresses the convergence criteria; and
(I) training the predictive model using the final subset of selected features.

13. The computer system of claim 12, wherein the feature selection process comprises:
matching cases and controls to select a plurality of case-control subsets for the first subset of features, each case-control subset having similar values for the corresponding subset of features;
identifying, for each case-control subset, a statistical significance of each feature of the plurality of features absent from the subset of features used to match the case-control subset; and
rewarding features of the second subset when they address a statistical significance criteria.

14. The computer system of claim 12, wherein the cumulative reward measure is a sum of all values in the table divided by a number of iterations.

15. The computer system of claim 12, wherein the convergence criteria is met based on a deviation of a calculated cumulative reward measure of the current iteration from an immediately prior calculated cumulative reward measure being less than a predetermined threshold.

16. The computer system of claim 12, wherein the convergence criteria is met based on a deviation of a calculated cumulative reward measure of the current iteration from a moving average cumulative reward measure of an immediately previous set of iterations being less than a predetermined threshold.

17. The computer system of claim 12, wherein rewarding one or more features of the second subset of features comprises rewarding each feature that addresses a statistical significance threshold in the second subset of features by a constant value.

18. The computer system of claim 12, wherein rewarding one or more features of the second subset of features comprises rewarding each feature that addresses a statistical significance threshold in the second subset of features by a variable value, wherein the variable value is a function of at least one of a type of feature, a number of iterations, and a number of selected features.

19. A computer program product for training a predictive model, the computer program product comprising one or more computer readable storage media collectively having program instructions embodied therewith, the program instructions executable by a computer to cause the computer to rank features using a dataset, features, and an outcome:
(A) initiating a table for a dataset comprising a plurality of numerical values for each pair of features;
(B) randomly selecting a plurality of features from the dataset, thereby creating a first subset of features;
(C) operating a propensity score matching on the dataset to identify a subset of cases and controls using the outcome variable;
(D) rewarding one or more features of a second subset of features consisting of features in the plurality of features that were not selected randomly when each addresses a statistical significance criteria;
(E) updating each entry in the table with a reward distance between each pair of features;
(F) calculating a cumulative reward measure;
(G) iterating steps (B)-(F) until a convergence criteria is met;
(H) selecting a final subset of features when a variability criteria of the cumulative reward measures addresses the convergence criteria; and
(I) training the predictive model using the final subset of selected features.

20. The computer program product of claim 19, further comprising:
evaluating the predictive model against a reference model to validate accuracy of the predictive model using the final subset of selected features, wherein the predictive model and the reference models are trained using the dataset.
